(19) United States
(12) Patent Application Publication
(10) Pub. No.: US 2014/0123968 A1
(43) Pub. Date: May 8, 2014

(54) METHOD AND APPARATUS FOR CONTROLLING THE OPERATION OF A TURBOCHARGED INTERNAL COMBUSTION ENGINE

(71) Applicants: Alistair Farman, Walton (GB); Michael Smith, Cambridegeshire (GB); Anthony Rodman, Peoria, IL (US); Matthew Nicholson, Peterborough (GB)

(72) Inventors: Alistair Farman, Walton (GB); Michael Smith, Cambridegeshire (GB); Anthony Rodman, Peoria, IL (US); Matthew Nicholson, Peterborough (GB)

(21) Appl. No.: 14/127,550

(22) PCT Filed: Jun. 29, 2012
(86) PCT No.: PCT/GB2012/051527

§ 371 Date: Dec. 19, 2013

(30) Foreign Application Priority Data
Jun. 29, 2011 (GB) 1111084.8

(51) Int. Cl. F02M 25/07

(52) U.S. Cl. CPC F02M 25/0706
USPC 123/676

(57) ABSTRACT

A method and apparatus for controlling the operation of a turbocharged internal combustion engine 10 with an exhaust gas aftertreatment device 20, wherein the operation of a wastegate of the turbocharger is based upon the exhaust gas aftertreatment device temperature and at least one of engine speed, engine fuel injection quantity, coolant temperature, ambient temperature and barometric pressure.

### TECHNICAL FIELD

This disclosure relates to the technical field of methods and apparatuses for controlling the operation of a turbocharged internal combustion engine.

### BACKGROUND

The majority of modern internal combustion engines include exhaust gas aftertreatment device (EATD), located at the engine exhaust in order to reduce nitrogen oxide (NO or NO2, collectively known as NOx) and/or particulate emissions from the engine. Various different types of EATD are available, for example diesel oxidation catalysts, diesel particulate filters and selective catalytic reduction (SCR) systems for the treatment of different types of particulate emission or NOx emissions.

During operation of an SCR system, it is important that the temperature of the system is maintained above a critical temperature, which is dependent upon a number of factors, including the type of reductant used within the catalyst. The addition of an aqueous urea solution reductant, for example AdBlue®, to the SCR system via injection into the exhaust stream, requires a critical temperature for decomposition and hydrolysis of the urea to ammonia (NH₃). Both the reaction and reaction rate of NH₃ and NOx is dependant upon a number of factors, including the temperature of the SCR catalyst. It may be important that the SCR system is maintained above at least 200° C. and preferably above about 250° C. to ensure that most of the urea can successfully dissociate and form ammonia while minimising side reactions and the formation of deposits within the SCR system, and achieve adequate selective NOx reduction through reaction with NH3. SCR system temperatures may vary during the operation of the engine as a result of a number of different factors, including, but not limited to, the engine speed and load condition, the ambient air temperature, the barometric pressure and the air-fuel-ratio (AFR) of the engine. If the SCR system temperature falls significantly below about 250° C., both the selective NOx reduction rate with NH₃ and the dissociation of NH₃ from urea will significantly reduce. This may result in both a reduction in NOx reduction performance and the formation of urea deposits within the SCR system, which may further decrease the effectiveness of the system.

At times during the operation of the engine, it might be necessary to ‘regenerate’ the EATD. Regeneration may include one or all of the removal of soot from the EATD, the removal of urea deposits from the exhaust gas after treatment device and desulphation of the EATD, and may be carried out at least in part by heating the EATD to a temperature exceeding its normal operating temperature, for example 450° C.-650° C. This increase in temperature might be achieved by hydrocarbon dosing, wherein hydrocarbons (HC), in the form of non-combusted fuel, are either injected as a non-combusting injection in the engine cylinder or injected directly into the exhaust gas stream to be transported to the EATD to generate an exothermic reaction. This exothermic reaction is sufficient to increase the temperature of the EATD to the required ‘regeneration’ temperature. The ignition of the catalytic exothermic reaction may only take place if a minimum critical temperature of the EATD is reached before hydrocarbon dosing takes place.

It is known that the temperature of EATD may be increased to the temperatures required for hydrocarbon dosing by increasing exhaust gas temperature. Japanese patent document JP59105915 describes a method of preventing the temperature of exhaust gas from a turbocharged diesel engine from lowering when regeneration of the EATD is desired. In the described method, when regeneration is required, a wastegate in the turbocharger is forcibly opened in order to send exhaust gas directly through the wastegate to the EATD. By using the wastegate to bypass the turbocharger, the diverted exhaust gas does no work on the turbine of the turbocharger and the diverted exhaust gas temperature is consequently higher when it reaches the EATD. Additionally, bypassing exhaust gas through the wastegate lowers the supercharging pressure generated by the turbocharger which has the effect of lowering the amount of air drawn into the inlet manifold of the engine, thus lowering the air-fuel ratio which may cause the temperature of the exhaust gas output from the engine to increase.

The method taught in JP59105915 is put into effect only when regeneration of the EATD is desired. It does not consider the temperature of the EATD during normal operation. Consequently, operation of the method taught in JP59105915 will not prevent the EATD temperature falling below the temperature required for effective operation of the EATD during normal operation of the engine and NOx emissions may therefore rise to levels above regulatory maxima.

### SUMMARY

The disclosure provides: a method of controlling the operation of a turbocharged internal combustion engine with an exhaust gas after treatment device, comprising the steps of: obtaining a measure of the exhaust gas after treatment device temperature; identifying at least one of engine speed, engine fuel injection quantity, coolant temperature, ambient temperature and barometric pressure; and determining the operation of a wastegate of the turbocharger based upon the exhaust gas after treatment device temperature and at least one of engine speed, engine fuel injection quantity, coolant temperature, ambient temperature and barometric pressure.

The disclosure also provides: a controller to control the operation of a turbocharged internal combustion engine with an exhaust gas after treatment device, configured to: obtain a measure of the exhaust gas after treatment device temperature; identify at least one of engine speed, engine fuel injection quantity, coolant temperature, ambient temperature and barometric pressure, and determine the operation of a wastegate of the turbocharger based upon the temperature of the exhaust gas after treatment device and at least one of engine speed, engine fuel injection quantity, coolant temperature, ambient temperature and barometric pressure.

An embodiment of the disclosure will now be described, by way of example only, with reference to the accompanying drawings.

### BRIEF DESCRIPTION OF THE DRAWINGS

FIG. 1 shows a schematic drawing of a turbo charged internal combustion engine with an exhaust gas aftertreatment device and an engine controller;

FIG. 2 shows a schematic drawing of the engine controller;

FIG. 3 shows a vehicle comprising the turbo charged internal combustion engine.

### DETAILED DESCRIPTION

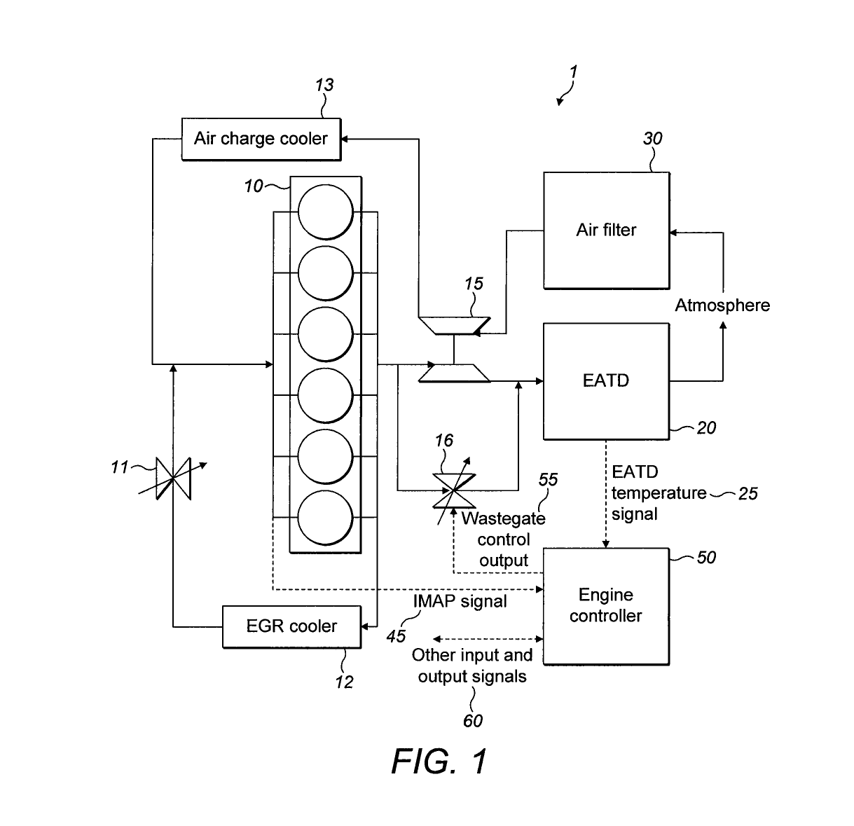

FIG. 1 shows an arrangement of a turbocharged internal combustion engine 1, which could be a diesel engine or petrol/gasoline engine with an exhaust gas aftertreatment device (EATD) 20, wherein the turbocharger 15 may be located between the engine exhaust manifold of the engine 10 and the inlet to the EATD 20. A compressor within the turbocharger 15, powered by a turbine within the turbocharger 15 which may be driven by the exhaust gas of the engine, increases the pressure of the air entering the intake manifold of the engine 10 above atmospheric pressure by an amount often described as ‘boost pressure’.

Other, optional components of the arrangement shown in FIG. 1 may include an exhaust gas recirculation (EGR) valve 11, an EGR cooler 12, an air charge cooler 13 and an air filter 30.

At times, it may be desirable to operate the engine with an either reduced or limited boost pressure for reasons including, but not limited to, the prevention of turbo overspeed, limitation of the engine cylinder pressure, and/or limitation of the air charge cooler heat rejection.

For this reason, turbochargers often include a wastegate 16, which is a valve that, when open, diverts exhaust gases away from the turbine of the turbocharger 15. The wastegate 16 may open to varying degrees, regulating the turbine rotation speed, which in turn may regulate the compressor rotation speed and, consequently, the boost pressure.

For a given fuel injection quantity, variations in the inlet manifold pressure, caused either by changes in boost pressure, or as a consequence of some other effects such as, but not limited to, changes in ambient pressure, may change the air-fuel-ratio (AFR) of the engine. The change in AFR of the engine may affect the exhaust gas temperature. In a lean burn engine with equivalence ratios less than one, for example a typical diesel engine, and in the engine of the present disclosure, a decrease in AFR may result in an increase in exhaust gas temperature. Consequently, opening the wastegate 16 of the turbocharger 15 may have the effect of increasing the exhaust gas temperature by decreasing the AFR. Furthermore, when the wastegate 16 is arranged such that exhaust gas passing through the wastegate 16 is reintroduced to the exhaust gas stream downstream of the turbocharger 15 and upstream of the EATD 20 (as shown in FIG. 1) the temperature of the exhaust gas through the EATD 20 may be even further increased by reducing the work done by the exhaust gas on the turbine.

The EATD 20 may comprise, but is not limited to, one or more of a diesel oxidation catalyst, a diesel particulate filter and a selective catalytic reduction (SCR) system. The choice of components within the EATD may depend upon which exhaust gas emissions are desired to be reduced before the exhaust gas may be released into the atmosphere. For example, SCR systems may be particularly effective in the selective conversion of NOx to Nitrogen (N₂) and water (H₂O).

The components within the EATD 20 will typically have a threshold temperature, above which their operation may be improved. For example, SCR systems require a reductant for their operation, which might be an aqueous urea solution periodically injected into the SCR system. Below an SCR system temperature of about 200° C.-250° C., the aqueous urea may not dissociate to form ammonia (NH₃), but may instead form urea deposits within the exhaust gas after treatment device. Consequently, not only may NOx conversion efficiency potentially be decreased due to the urea aqueous solution not dissociating to form NH₃, the subsequent efficiency of the exhaust gas after treatment device, even when the SCR system temperature is again above 250° C., may be decreased due to the presence of urea deposits. Consequently, it may be desirable to maintain the SCR system temperature above a minimum of 200° C. and ideally between about 250° C. and 450° C. during operation of the engine.

In the present disclosure, there is described a method of controlling the operation of a turbocharged internal combustion engine 1 with an EATD 20, of the type shown in FIG. 1 and described above.

In the first step of the best mode of the disclosed method, the temperature of the EATD 20 may be identified. There are multiple different suitable measures of the EATD 20 temperature, one of which may be the exhaust gas temperature at the inlet to the EATD 20, which may be obtained by a temperature sensor located at the inlet of the EATD 20. Since the exhaust gas temperature may be one of the factors that affects the temperature of the EATD 20, a measurement of the exhaust gas temperature at the inlet of the EATD 20 may provide a good measure of the temperature of the EATD 20. In addition to, or as an alternative to, measuring the exhaust gas temperature at the inlet of the EATD 20, the exhaust gas temperature at the outlet of the EATD 20 might be measured. Other measures of the EATD 20 temperature may include estimating the substrate temperature of the EATD 20 from the measured exhaust gas temperature at the inlet and/or outlet of the EATD 20, and estimating an exhaust gas cycle mean temperature calculated by monitoring the exhaust gas temperatures at the inlet and/or outlet of the EATD 20 over a predetermined cycle period. The predetermined cycle period might typically be a period of time within the range of 60-3600 seconds, for example 1200 seconds. Other measures of the EATD 20 temperature, including, but not limited to, physically modelled and empirically referred virtual measurements, and/or surface/embedded thermocouple sensors within the substrates, will be known to the person skilled in the art.

In the next step of the best mode of the disclosed method, engine operation parameter figures are identified, which might include, but are not limited to, at least one of engine speed, engine fuel injection quantity, coolant temperature, ambient temperature and barometric pressure. Methods for identifying these engine parameters will be well known to the person skilled in the art.

Having performed these first two steps, the operation of the wastegate 16 may be determined, based upon the identified temperature of the EATD 20, and at least one of engine speed, engine fuel injection quantity, coolant temperature, ambient temperature and barometric pressure. As explained earlier, the degree of opening of the wastegate 16 affects the AFR of the engine and consequently the exhaust gas temperature. Therefore, by adjusting the degree of opening of the wastegate 16, it may be possible to control the temperature of the EATD 20 and maintain it within a desired operating range.

After performing this final step, the method may return to the first step and repeat the loop of method steps so as to control the temperature of the EATD 20 continually for a period of control, which might last for the entire operating period of the engine. The control period, and intervals between control periods, might be determined by a variety of different factors including, but not limited to, the environmental and ambient conditions of the engine, the engine installation, location and use, the speed and load operation of engine, and operating demands put upon the engine.

By carrying out this method, either once or repeatedly in a loop, it may be possible to adjust and control the temperature of the EATD 20. In consequence, the EATD 20 temperature may be maintained above desired levels over a greater range of engine loads and speeds.

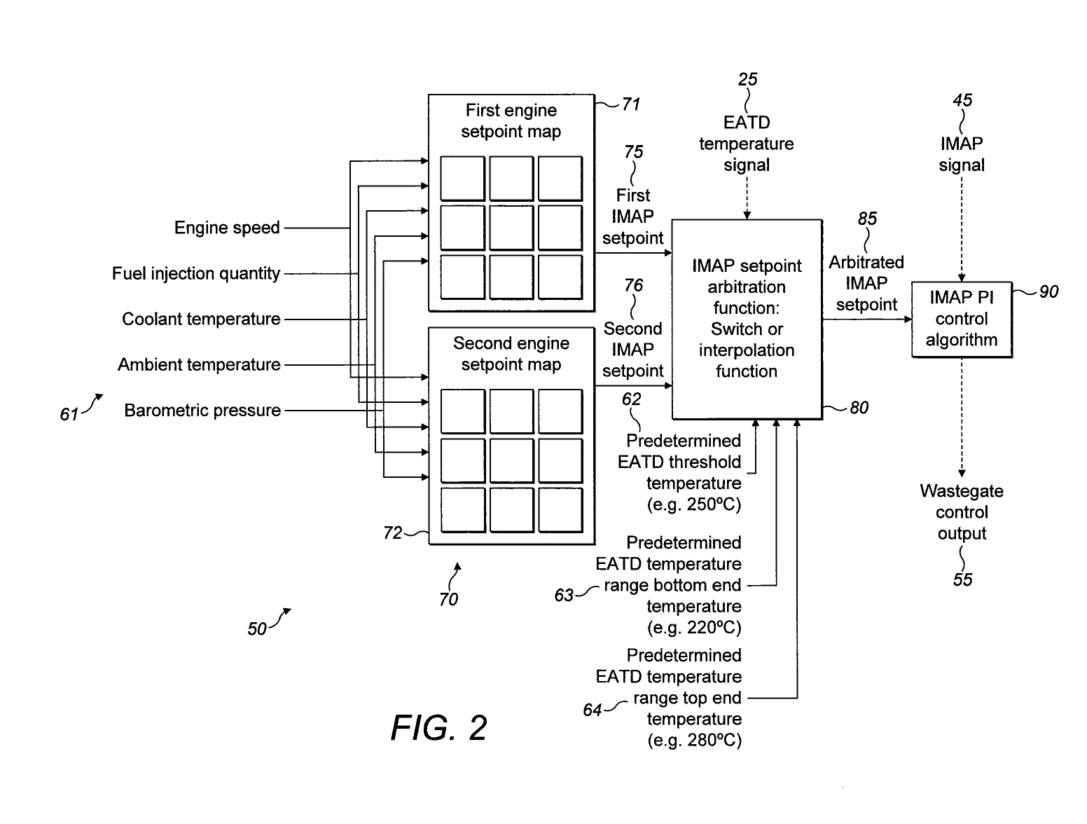

In a further aspect of the present disclosure, the operation of the wastegate 16 might be determined by at least two sets of engine set point maps. FIG. 2 shows a schematic drawing of the engine controller 50, which includes a group of engine set point maps 70, comprising first 71 and second 72 engine set point maps for controlling the operation of the wastegate 16. Engine set point maps consider a number of different engine parameters to determine the operation of a number of different engine components. For any given engine parameter value, or combination of parameter values, the engine set point map may determine the operation of the engine component it is controlling.

The engine parameters 61, which might form part of the ‘other input and output signals’ 60 shown in FIG. 1, considered by the first 71 and second 72 engine set point maps might include, but are not limited to, at least one of engine speed, engine fuel injection quantity, coolant temperature, ambient temperature and barometric pressure. The degree of opening of the wastegate 16 may be determined by the first 71 and second 72 engine set point maps in consideration of at least one of these parameters.

The first engine set point map 71 may be used for medium to high EATD 20 temperatures. Medium to high EATD 20 temperatures are the temperatures at which the components comprising the EATD 20 operate most efficiently, and so the exact temperature ranges that define a ‘medium to high temperature’ are dependant upon the components that comprise the EATD 20. For example, if the EATD 20 comprises an SCR system, the medium to high temperature range might typically be temperatures above 200° C., and most preferably above 250° C. At this temperature range, the temperature of the EATD 20 does not need to be increased, so the first engine set point map 71 may operate the wastegate 16 to optimise other aspects of the internal combustion engine and/or ancillary components, for example engine power output or fuel efficiency.

The second engine set point map 72 may be similar to the first 71, but may be modified to control the operation of the wastegate 16 at low EATD 20 temperatures. Low EATD 20 temperatures are the temperatures at which the components comprising the EATD 20 operate inefficiently, and so the exact temperature ranges that define a ‘low temperature’ are dependant upon the components that comprise the EATD 20. For example, if the EATD 20 comprises an SCR system which utilises an aqueous urea solution as its reductant, if the temperature of SCR system falls below 250° C. the efficiency of the selective NOx reaction is reduced and below 200° C. the reductant may not readily dissociate to from ammonia to adsorb onto the SCR catalyst and instead form urea deposits within the EATD 20, which may cause inefficient operation of the EATD 20. Therefore, the low temperature range might typically include all temperatures below 200° C., and most preferably all temperatures below 250° C. When the EATD 20 temperature is within this temperature range, the temperature of the EATD 20 should be increased to the medium to high temperature range, where efficient operation may be realised. As such, the second engine set point map 72 may be optimised to raise the temperature of the EATD 20.

The temperature of the EATD 20 may be raised whilst the second engine set point map 72 is determining the operation of the wastegate 16 by increasing the temperature of the exhaust gases. As previously explained, when the wastegate 16 is opened to a greater degree, the AFR of the engine may decrease, and the exhaust gas temperature may consequently increase. The second engine set point map 72 may therefore be modified such that for any given values, or combination of values, of at least one of the engine parameters utilised by the second engine set point map 72 (which might include, but are not limited to, engine speed, engine fuel injection quantity, coolant temperature, ambient temperature and barometric pressure) the degree of opening of the wastegate 16 may be the same or greater than when the first engine set point map 71 is determining the operation of the wastegate 16.

There may be some parameter 61 values, or combinations of values, where the degree of opening of the wastegate 16 may be the same when operating on either the first 71 or second 72 engine set point map, due to other important engine operation considerations. For example, the load on the engine might be such that the measured parameters 61 would result in the wastegate 16 being kept fully closed by either the first 71 or second 72 engine set point maps in order to build up required boost pressure. Likewise, for some parameter 61 values, or combination of values, the wastegate 16 may be fully open when operating on the first engine set point map 71, such that for those parameter 61 values, or combination of values, the second engine set point map 72 would not be able to open the wastegate 16 to any greater degree than it would be open under operation by the first engine set point map 71. However, there are some parameter 61 values, or combination of values, at which the wastegate 16 map be open to a greater degree when controlled by the second engine set point map 72 compared with the first engine set point map 71, and at those parameter 16 values, or combination of values, the exhaust gas temperature may be increased by the second engine set point map 72 compared with the first 71.

In order to transition between the first 71 and second 72 engine set point maps, the temperature of the EATD 20 may be utilised. In one mode of operation, called the ‘switch mode’ of operation, the operation of the wastegate 16 may be controlled by either the first engine set point map 71 or the second engine set point map 72. Which of the engine set point maps used may be determined by on which side of a predetermined threshold temperature 62 the EATD 20 temperature lies. For example, if the temperature of the EATD 20 is above a predetermined threshold 62, the EATD 20 temperature may be deemed to be medium to high, and control of the operation of the wastegate 16 may be performed entirely by the first engine set point map 71. If the temperature of the EATD 20 is below the predetermined threshold temperature 62, the EATD 20 temperature may be deemed to be low, and control of the operation of the wastegate 16 may be performed entirely by the second engine set point map 72. Transition from the first 71 to second 72 engine set point map, or second 72 to first 71 engine set point map, may be executed as soon as the EATD 20 temperature goes below or above the predetermined threshold temperature 62 respectively.

In the arrangement shown in FIG. 2, a number of engine parameters 61, including engine speed, fuel injection quantity, coolant temperature, ambient temperature and barometric pressure, are used as inputs to the first 71 and second 72 engine set point map. Based upon the values of these parameters 61, the first 71 and second 72 engine set point maps may generate first 75 and second 76 intake manifold air pressure (IMAP) setpoints respectively. The first 75 and second 76 IMAP setpoints are used as inputs to an IMAP Setpoint Arbitration Function 80. When operating in ‘switch mode’, the IMAP Setpoint Arbitration Function 80 compares an EATD Temperature Signal 25 with the predetermined threshold temperature 62 to determine which of the first 75 or second 76 IMAP setpoints should be used to control the wastegate 16 (i.e. whether the waste gate 16 should be controlled by the first 71 or the second 72 engine set point map). The chosen IMAP Setpoint is output from the

IMAP Setpoint Arbitration Function 80 as the Arbitrated IMAP Setpoint 85. The Arbitrated IMAP Setpoint 85 is then used, along with by an IMAP proportional integrator (PI) Control Algorithm 90 to control the operation of the wastegate 16 by generating a wastegate control output signal 55. In addition to the arbitrated IMAP setpoint 85, the IMAP PI Control Algorithm 90 may also use an IMAP signal 14, derived from a pressure sensor in the intake manifold or by any other means that would be well known to the skilled person, as a feedback signal.

The value of the predetermined threshold temperature 62 may be dependent upon which components comprise the EATD 20. For example, if the EATD 20 comprises an SCR system which utilises an aqueous urea solution as a reductant, the threshold temperature 62 might be set at 200° C., or more preferably at 250° C., in order to maintain efficient operation of the SCR system.

In an alternative mode of operation, called the ‘interpolation function mode’ of operation, transition between the first 71 and second 72 set point maps may take place gradually over a predetermined range of EATD 20 temperatures using an interpolation factor derived from the EATD 20 temperature. As such, whilst the EATD 20 temperature is above the top of the temperature range 64, the temperature may be considered to be medium to high and the first engine set point map 71 may be used to control operation of the wastegate 16. Whilst the EATD 20 temperature is below the bottom of the temperature range 63, the temperature may be considered to be low and the second engine set point map 72 may be used to control operation of the wastegate 16. Whilst the EATD 20 temperature is within the predetermined temperature range, the engine set point map used to control operation of the wastegate 16 may be a hybrid of the first 71 and second 72 engine set point maps. For example, if the EATD 20 temperature is in the middle of the predetermined range, assuming a linear interpolation method, the hybrid engine set point map may have operation set points half way between those of the first 71 and second 72 engine set point maps. In this example, if for a particular value or combination of values of at least one of the engine parameters 61 the wastegate 16 would be ¼ open under operation controlled by the first engine set point map 71, and ¾ open under operation controlled by the second engine set point map 72, the wastegate 16 would be controlled to be ½ open under the linear interpolation transition technique. The method of interpolation used is not limited only to linear interpolation, and any number of non-linear interpolation methods may be utilised.

When operating in ‘interpolation function mode’ the arrangement shown in FIG. 2 may operate in a similar way to the above described operation in ‘switch mode’. The difference may lie in the operation of the IMAP Setpoint Arbitration Function 80. In order to determine the Arbitrated IMAP Setpoint 85, the IMAP Setpoint Arbitration Function 85 may consider the EATD Temperature Signal 25, and the top 64 and bottom 63 values of the predetermined EATD temperature range. By comparing the EATD Temperature Signal 25 with the predetermined temperature range, the IMAP Setpoint Arbitration Function 80 may determine whether the EATD 20 temperature is to be considered medium to high, low or within the predetermined temperature range. If the EATD 20 temperature is medium to high, the Arbitrated IMAP Setpoint 85 may be the same as the first IMAP setpoint 75.

If the EATD 20 temperature is low, the Arbitrated IMAP setpoint 85 may be the same as the second IMAP setpoint 76. If the EATD 20 is within the predetermined temperature range, the Arbitrated IMAP Setpoint 85 may be a hybrid of the first 75 and second 76 IMAP Setpoints, determined by an interpolation function which considers where within the predetermined temperature range the EATD temperature signal 20 lies.

The predetermined temperature range may be dependent upon which components comprise the EATD 20. For example, if the EATD 20 comprises an SCR system which utilises an aqueous urea solution as a reductant, the temperature range might be 200° C. to 300° C., or more preferably 220° C. to 280° C., in order to maintain efficient operation of the SCR system.

By judiciously selecting the predetermined threshold temperature 62 or temperature range 63,64, even if the EATD 20 temperature falls below the threshold temperature 62, or the top end of the temperature range 64, it may still be possible to maintain the EATD 20 temperature above the critical temperature required for its operation for a prolonged period. For example, even if for a set of the measured engine parameters 61 the degree of opening of the wastegate 16 under control by the second engine setpoint map 72, or the hybrid engine setpoint map, cannot be increased compared with control under the first engine setpoint map 71 (possible for reasons explained previously), the EATD 20 temperature may still be maintained above the critical temperature required for its operation.. This may be achieved by setting the threshold temperature 62, or temperature range 63,64, sufficiently high such that when operating under normal conditions (the EATD 20 temperature being medium to high) the EATD 20 temperature may be relatively high. When the temperature falls below the threshold temperature 62, or into the temperature range 63,64, a large further drop in temperature would still be required before the EATD 20 might fall below its critical temperature. Therefore, even if the second engine set point map 72, or the hybrid engine set point map, is not able to open the wastegate 16 any further compared with the first engine set point map 71, there may still be a considerable period of time before the EATD 20 falls below its critical temperature, during which time the measured engine parameters may have changed sufficiently that the second engine set point map 72, or the hybrid engine set point map, may be able to open the wastegate 16 more fully and start to increase the exhaust gas temperature. Consequently, the temperature of the EATD 20 may be maintained above its critical temperature over a greater range of engine speeds and loads.

For example, if the EATD 20 comprises an SCR system with a critical operation temperature of about 200° C., if the temperature threshold 62 is set at about 250° C., or the temperature range set at about 220° C. to 280° C., during the time it would take for the exhaust gas temperature to fall from 280° C. or 250° C. to about 200° C., the measured engine parameters 61 are likely already to have changed sufficiently for the wastegate 16 to be opened according by the second engine set point map 72 (or the hybrid engine set point map), and the exhaust gas temperature subsequently increased.

During normal operation of an internal combustion engine, there may be times when a sudden increase in load and/or desired engine speed is demanded, and in order to meet that demand, engine power might need to be increased. One way of achieving this in a turbocharged internal combustion engine might be to increase boost pressure, which in turn will increase the mass of air taken into the engine cylinders, enabling a greater volume of fuel to be injected into the cylinders of the engine. The increase in boost pressure may be achieved by closing the wastegate 16.

This might be problematic in the disclosed method since the boost pressure and, therefore, the intake manifold pressure, might be low at the time a sudden increase in load and/or desired engine speed is demanded of the engine. Consequently, for a given AFR limit, the amount of fuel that may instantaneously be injected in response to a sudden increased demand may be reduced. Furthermore, when the initial boost level at the time of sudden increased demand is low, it may take time for the required boost pressure to be built up. This may have an adverse impact on the response of the engine to sudden increases in load and/or desired engine speed.

Therefore, in a further aspect of the present disclosure, a step of monitoring an early indicator signal, which might form part of the ‘other input and output signals’ 60 shown in FIG. 1, which indicates an anticipated sudden increase in load and/or desired engine speed may be carried out. Upon detection of the early-indicator signal, the wastegate 16 may be closed as fast as possible within the dynamic constraints of the wastegate 16 actuator in question. This rapid closure of the wastegate 16, regardless of other measured engine parameters 61 and which engine set point map is currently determining the operation of the wastegate 16, may enable boost pressure to begin building before the anticipated increase in load and/or desired engine speed is demanded. In this way, it may be possible to decrease the lag between more power being required of engine and the engine being able to deliver the power, making the engine more responsive to transient events such as increases in load and/or changes in desired engine speed.

Ordinarily, a rapid increase in engine power, generated by increased fuel injection volume, might cause a spike in engine emissions, including but not limited to, particulate emissions and gaseous NOx emissions. However, because in the disclosed method it may be arranged that the EATD 20 temperature might already be high when an early indicator signal might be detected, the EATD 20 may already be running with a high conversion efficiency and any spikes in emissions caused by the rapid closure of the wastegate 16 may be easily absorbed.

There are a number of different methods for triggering the early-indicator signal, including, but not limited to, a rate-of-change of fuel injection quantity figure exceeding a predetermined threshold and/or a rate-of-change of desired engine speed indicator signal exceeding a predetermined threshold and/or a feed forward fuel demand signal, or other such feed forward demand signals, for example a feed forward signal generated by a Load Enhanced Anticipatory Control (LEAC) system. A rate-of-change of fuel injection quantity figure and rate-of-change of desired engine speed indicator signal may be obtained by a number of different methods known in the art, for example calculating the rate-of-change of fuel demand signal from the engine speed governor logic, and/or utilising an external signal transmitted to the engine controller 50 anticipating an increase in torque demand from the engine derived from signals available to the machinery using the engine. The predetermined thresholds might be dependent upon a number of different factors, including, but not limited to, the engine size and type, operating location of the engine and operating demands put upon the engine. For example, a 6.6L single turbocharged diesel engine might have a rate-of-change of fuel threshold of about 10 mm 3/st fuel delivery in 15 ms for the same type of engine.

In a further aspect of the present disclosure, control of hydrocarbon dosing might be provided. Hydrocarbon dosing is a technique of regenerating the EATD 20, whereby the temperature of the EATD 20 is increased to a temperature sufficient for hydrocarbons (HC), which are either injected as a non-combusting injection in the engine cylinder or injected directly into the exhaust gas stream to be transported to the EATD 20, to combust and generate an exothermic reaction. For the exothermic reaction to take place, the EATD 20 temperature should be above, for example, about 250° C. After the exothermic reaction takes place, the temperature of the EATD 20 is even further increased and reaches the regeneration temperature. Regeneration temperatures vary depending on the components comprising the EATD 20, but by way of example, the particulate matter regeneration of a Diesel Particulate Filter (DPF) may require temperatures of approximately 550° C. to 600° C., whereas the de-sulphation and deposit removal of a cooper zeolite SCR system may require temperatures of approximately 450° C. to 550° C.

When hydrocarbon dosing is required, the wastegate 16 may be opened, regardless of other measured engine parameters 61 or which engine set point map is controlling the operation of the wastegate 16 at the time, in order to decrease the AFR and increase the EATD 20 temperature. Once the measured EATD 20 temperature is sufficiently high, for example above about 250° C., hydrocarbons may be injected as a non-combusting injection in the engine cylinder or injected directly into the exhaust gas stream so that they may combust in the EATD 20 and raise the temperature of the EATD 20 execute regeneration further to the required regeneration temperature. Control of the wastegate 16 may then return to normal operation, or the regeneration process may be repeated, if necessary.

In a further aspect of the present disclosure, where the EATD 20 comprises at least an SCR system with a reductant of injected aqueous urea solution, control of the injection timing of the aqueous urea solution may be carried out in an additional method step. As previously explained, at SCR system temperatures of below about 200° C., the aqueous urea solution may not readily dissociate to form and might instead form urea deposits within the EATD 20, which may diminish the efficiency of the device. To limit urea deposits, injection of the aqueous urea solution may be limited only to times when the measured temperature of the EATD 20 is above about 200° C., and most preferably above about 250° C.

A further advantage of the disclosed method is that the EATD 20 may be maintained at a higher temperature over a greater range of engine speeds and load operating conditions. Not only can this result in the EATD 20 operating more efficiently over a greater range of engine speeds and loads, it is also possible to execute hydrocarbon dosing and inject aqueous urea solution into an SCR system, should the EATD 20 comprise an SCR system, over a greater range of engine speeds and loads, which can even further increase efficiency.

The engine controller 50, which is arranged to control the operation of a turbocharged internal combustion engine with an exhaust gas after treatment device in accordance with the above described methods, may be implemented as a control block within an engine control unit (ECU) in the best mode of the disclosed apparatus. Alternatively, the engine controller 50 may be implemented within a standalone control unit which may interface with the ECU and any other engine control and monitoring systems, or it may be implemented within the wastegate (16) actuator, or in any other arrangement that would be immediately clear to the person skilled in the art.

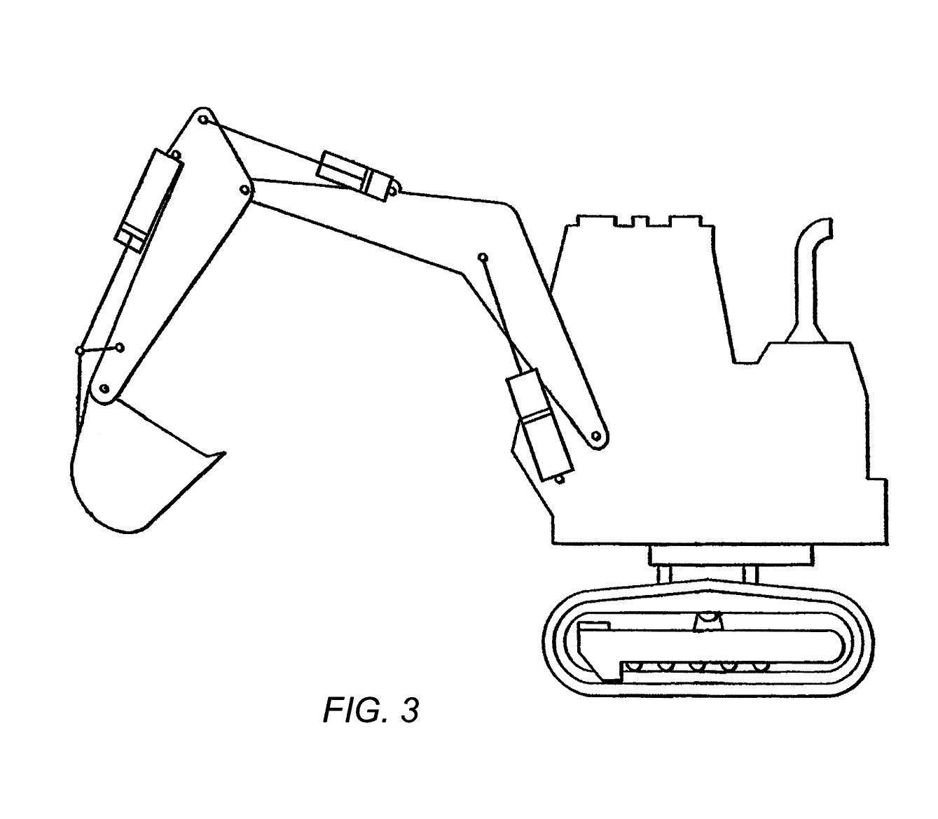

FIG. 3 shows a vehicle 100 comprising the turbocharged internal combustion engine 1, which includes the engine controller 50, as described above.

### INDUSTRIAL APPLICABILITY

The present disclosure finds application in controlling the operation of turbocharged internal combustion engines and leads to improvements in the operation of exhaust gas aftertreatment devices (EATD).

1. A method of controlling the operation of a turbocharged internal combustion engine with an exhaust gas aftertreatment device, comprising the steps of:
obtaining a measure of the exhaust gas aftertreatment device temperature;
identifying at least one of engine speed, engine fuel injection quantity, coolant temperature, ambient temperature and barometric pressure; and
determining the operation of a wastegate of the turbocharger based upon the exhaust gas aftertreatment device temperature and at least one of engine speed, engine fuel injection quantity, coolant temperature, ambient temperature and barometric pressure.

2. The method of claim 1, wherein:
operation of the wastegate is determined by at least two engine set point maps, the first engine set point map being used for medium to high exhaust gas aftertreatment device temperatures, the second engine set point map being used for low exhaust gas aftertreatment device temperatures.

3. The method of claim 2, wherein:
transition between use of the first engine set point map and the second engine set point map takes place gradually over a range of exhaust gas aftertreatment device temperatures using an interpolation factor derived from the exhaust gas after treatment device temperature.

4. The method of claim 2, wherein:
the first and second engine set point maps determine the operation of the wastegate based upon at least one of engine speed, engine fuel injection quantity, coolant temperature, ambient temperature and barometric pressure; and
the second engine set point map is optimised to decrease the air-fuel-ratio (AFR) of the engine through the operation of the wastegate, such that for given values of at least one of engine speed, engine fuel injection quantity, coolant temperature, ambient temperature and barometric pressure, the degree of opening of the wastegate when the second engine set point map determines the operation of the wastegate is the same or greater than when the first engine set point map determines the operation of the wastegate.

5. The method of claim 1, wherein:
an early-indicator signal, which indicates an anticipated sudden increase in load and/or desired engine speed, is monitored; and
upon detection of the early-indicator signal, the wastegate is rapidly closed to pre-emptively begin building boost pressure in advance of the increased load and/or desired engine speed being demanded of the engine.

6. The method of claim 1, wherein:
when hydrocarbon dosing is required, the wastegate is opened to decrease the air-fuel-ratio (AFR), thus increasing the exhaust gas aftertreatment device temperature above a temperature required for combustion of hydrocarbons within the exhaust gas aftertreatment device.

7. A controller to control the operation of a turbocharged internal combustion engine with an exhaust gas aftertreatment device, the controller configured to:
obtain a measure of the exhaust gas aftertreatment device temperature;
identify at least one of engine speed, engine fuel injection quantity, coolant temperature, ambient temperature and barometric pressure, and
determine the operation of a wastegate of the turbocharger based upon the temperature of the exhaust gas aftertreatment device and at least one of engine speed, engine fuel injection quantity, coolant temperature, ambient temperature and barometric pressure.

8. The controller of claim 7, further configured to:
store at least two engine set point maps; wherein
a first engine set point map is used to determine the operation of the wastegate for medium to high exhaust gas aftertreatment device temperatures; and
a second engine set point map is used to determine the operation of the wastegate for low exhaust gas aftertreatment device temperatures.

9. The controller of claim 8, further configured to:
transition between the first engine set point map and the second engine set point map gradually over a range of exhaust gas aftertreatment device temperatures using an interpolation factor derived from the exhaust gas after treatment device temperature.

10. The controller of claim 8, wherein:
the first and second engine set point maps are configured to determine the operation of the wastegate based upon one of engine speed, engine fuel injection quantity, coolant temperature, ambient temperature and barometric pressure; and
the second engine set point map is optimised to decrease the air-fuel-ratio (AFR) of the engine through the operation of the wastegate, such that for given values of at least one of engine speed, engine fuel injection quantity, coolant temperature, ambient temperature and barometric pressure, the degree of opening of the wastegate when the second engine set point map determines the operation of the wastegate is the same or greater than when the first engine set point map determines the operation of the wastegate.

11. The controller of claim 7, further configured to:
rapidly close the wastegate upon detection of an early-indicator signal which indicates an anticipated sudden increase in load and/or desired engine speed in order pre-emptively to being building boost pressure in advance of the increased load and/or desired engine speed being demanded of the engine.

12. The controller of claim 7, further configured to;
open the wastegate to decrease the air-fuel-ratio (AFR) of the engine, such that the temperature of the exhaust gas aftertreatment device is increased to above the temperature required for combustion of hydrocarbons within the exhaust gas aftertreatment device when hydrocarbon dosing is required.

13. A turbocharged internal combustion engine comprising the controller defined in claim 7.

14. A vehicle comprising the turbocharged internal combustion engine defined in claim 13.

15. The method of claim 2, wherein:
transition between use of the first engine set point map and the second engine set point map is performed as a discrete switch between the two engine set point maps triggered by the exhaust gas aftertreatment device temperature crossing a pre-determined threshold.

16. The method of claim 3, wherein;
the first and second engine set point maps determine the operation of the wastegate based upon at least one of engine speed, engine fuel injection quantity, coolant temperature, ambient temperature and barometric pressure; and
the second engine set point map is optimised to decrease the air-fuel-ratio (AFR) of the engine through the operation of the wastegate, such that for given values of at least one of engine speed, engine fuel injection quantity, coolant temperature, ambient temperature and barometric pressure, the degree of opening of the wastegate when the second engine set point map determines the operation of the wastegate is the same or greater than when the first engine set point map determines the operation of the wastegate.

17. The method of claim 15, wherein:
the first and second engine set point maps determine the operation of the wastegate based upon at least one of engine speed, engine fuel injection quantity, coolant temperature, ambient temperature and barometric pressure; and
the second engine set point map is optimised to decrease the air-fuel-ratio (AFR) of the engine through the operation of the wastegate, such that for given values of at least one of engine speed, engine fuel injection quantity, coolant temperature, ambient temperature and barometric pressure, the degree of opening of the wastegate when the second engine set point map determines the operation of the wastegate is the same or greater than when the first engine set point map determines the operation of the wastegate.

18. The controller of claim 8, further configured to:
transition between the first engine set point map and the second engine set point map as a discrete switch between the two engine set point maps triggered by the exhaust gas aftertreatment device temperature crossing a pre-determined threshold.

19. The controller of claim 9, wherein:
the first and second engine set point maps are configured to determine the operation of the wastegate based upon one of engine speed, engine fuel injection quantity, coolant temperature, ambient temperature and barometric pressure; and
the second engine set point map is optimised to decrease the air-fuel-ratio (AFR) of the engine through the operation of the wastegate, such that for given values of at least one of engine speed, engine fuel injection quantity, coolant temperature, ambient temperature and barometric pressure, the degree of opening of the wastegate when the second engine set point map determines the operation of the wastegate is the same or greater than when the first engine set point map determines the operation of the wastegate.

20. The controller of claim 10, further configured to:
rapidly close the wastegate upon detection of an early-indicator signal which indicates an anticipated sudden increase in load and/or desired engine speed in order pre-emptively to being building boost pressure in advance of the increased load and/or desired engine speed being demanded of the engine.
